(19) United States
(12) Patent Application Publication
(10) Pub. No.: US 2025/0212870 A1
(43) Pub. Date: Jul. 3, 2025

(54) RAKING STICK GAME CALLING DEVICE

(71) Applicant: Eagle Cap Outdoors, LLC, Austin, TX (US)

(72) Inventors: Christopher Brian Woodburn, Austin, TX (US); Ted Douglas Karr, Austin, TX (US)

(21) Appl. No.: 19/002,463

(22) Filed: Dec. 26, 2024

Related U.S. Application Data
(60) Provisional application No. 63/615,233, filed on Dec. 27, 2023.

(51) Int. Cl. A01M 31/00

(52) U.S. Cl. CPC A01M 31/004

(57) ABSTRACT

Example methods, apparatuses, and/or articles of manufacture related to an attractant for wild game are disclosed that may be implemented, in whole or in part, using a raking stick for attracting bull elk, a bugle tube for calling bull elk and making cow, calf and/or bull elk sounds and a combination of a raking stick and a bugle tube. In a particular implementation, a device may closely imitate the sound of a bull elk raking a tree and/or ground while also being capable of imitating the bugle of a bull elk or cow elk sounds while air is pushed through one end of the raking stick and also being capable of imitating the sound of a bull elk glunking.

### CROSS-REFERENCES TO RELATED APPLICATIONS

This application claims the benefit of U.S. Provisional Patent Application No. 63/615,233 entitled “RAKING STICK GAME CALLING DEVICE” and filed on Dec. 27, 2023, for Christopher Woodburn, et al., which is incorporated herein by reference.

### TECHNICAL FIELD

The present disclosure relates to a raking stick elk game calling device for use to attract bull elk, and methods of its construction and use.

### BACKGROUND

Hunters have used a number of devices for imitating the sound of a bull elk raking a tree and/or ground. Hunters have also used a number of devices for calling or attracting the attention of wild animals, such as elk or other game, and in particular for attracting wild game through imitating the calls of elk, such as the vocalizations of bull, cow or calf elk as they communicate with one another in the wild. Still, there remains a need for improved devices.

### SUMMARY

Apparatuses, systems, and methods are disclosed for a game calling device for attracting wild game through imitating the vocalization and calls of elk and through imitating a bull elk scraping its antlers on a tree, shrub, the ground or other vegetation.

The raking stick game calling device may include a hollow tube with a first end having a first aperture, a handle portion, a baffle portion, and a second end opposite the first end. The wall of the tube may extend from the first end to the second end, having an inner and outer surface, where the inner surface defines an interior volume. The first aperture can provide access to the interior volume, and a flow path may be defined through the tube from the first end, through the interior volume, and out the second end. The tube can be configured to generate sound waves by vibrating in response to air flowing along the flow path.

The first end of the raking stick game calling device may have a first aperture flared as a mouthpiece.

The device may have a handle portion to be used to grip the device.

The device may have a raised portion between the first aperture flared as a mouthpiece and the handle portion to provide a grip stop.

The device may have a baffle portion to facilitate production of realistic elk sounds and to mimic elk raking a tree or the ground.

At least a section of the inner portion of the hollow tube may be shaped with ribs or contour to imitate an elk's esophagus.

The tube of the raking stick game calling device may be formed of plastic.

The diameter of any portion of the device is preferred to be no greater than 3 inches.

A portion or all of the exterior wall of the baffle portion of the tube may be configured with reinforcement material to strengthen the wall.

The baffle portion of the raking stick game calling device can have a consistent outer diameter and may not be tapered.

The thickness of the tube wall may be thinner in sections to reduce weight.

The preferred length of the device is over 22 inches in overall length but under 26 inches in overall length.

The raking stick game calling device may also comprise a solid tube with a first end having a handle and a second end opposite the first end. The wall of the tube can extend from the handle to the second end and may be shaped in the form of an antler with one or more points. The texture of the wall can be smooth or have raised nodes like an elk antler.

The handle of the raking stick game calling device may be wrapped in cork, foam, tape, or rubber.

The handle can have a raised portion near the first end to form a grip stop for the hand.

The tube of the raking stick game calling device may be formed of plastic. The overall length of the device can be between 22 and 26 inches.

The raking stick game calling device may also comprise a tube with a first end having a handle, a first hollow tube connected to the handle end, and a second hollow tube connected to the first hollow tube. The diameter of the second tube can be less than the diameter of the first tube, and the second tube may be able to slide at least partially into the first tube and have a means for fixedly securing the second tube in position. The device could have a third hollow tube connected to the second where the diameter of the third hollow tube is less than the diameter of the second hollow tube so the third hollow tube can slide at least partially into the second hollow tube and have a means for fixedly securing the third tube in position.

The outermost hollow tube of the raking stick game calling device may have a weight attachable to the end of the outermost hollow tube.

### BRIEF DESCRIPTION OF THE DRAWINGS

The present disclosure may be better understood, and its numerous features and advantages made apparent to those skilled in the art by referencing the accompanying drawings. Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings.

FIG. 1 is a perspective top view of a raking stick game calling device, according to an embodiment.

FIG. 2 is perspective top view of a raking stick game calling device, further illustrating the FIG. 1 embodiment.

FIG. 3 is a view of a raking stick game calling device from each end of the device.

FIG. 4 is a side view of a raking stick game calling device, according to another embodiment.

FIG. 5 is a side view of a raking stick game calling device, according to other embodiments.

FIG. 6 is a side view of a raking stick game calling device, according to another embodiment.

FIG. 7 is a side view of a raking stick game calling device, according to another embodiment.

FIG. 8 is a side view of a raking stick game calling device, according to another embodiment.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Furthermore, structural and/or other changes may be made without departing from claimed subject matter. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents. Further, it is to be understood that other embodiments may be utilized. Also, embodiments have been provided of claimed subject matter and it is noted that, as such, those illustrative embodiments are inventive and/or unconventional; however, claimed subject matter is not limited to embodiments provided primarily for illustrative purposes. Thus, while advantages have been described in connection with illustrative embodiments, claimed subject matter is inventive and/or unconventional for additional reasons not expressly mentioned in connection with those embodiments. In addition, references throughout this specification to “claimed subject matter” refer to subject matter intended to be covered by one or more claims, and are not necessarily intended to refer to a complete claim set, to a particular combination of claim sets (e.g., method claims, apparatus claims, etc.), or to a particular claim.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the patent application, particular context of description and/or usage provides helpful guidance regarding reasonable inferences to be drawn; however, likewise, “in this context” in general without further qualification refers to the context of the present patent application.

Present embodiments provide bull elk tree raking imitating devices and a combined bull elk tree raking imitating device and calling system and the methods of their manufacture, and methods of their use. Present embodiments provide various advantages and benefits related to ease of use over natural sticks and tree limbs and different diameter plastic bugle tubes. Wild game hunters often use a tree limb to strike trees and other vegetation outdoors to imitate the sound of a bull elk raking its antler or antlers on a tree and/or ground. Repeated imitation raking often causes soreness, scrapes and/or blisters on one or more of the hands of the individual imitating the raking and results in hand and arm fatigue due to the size and shape of the tree limb. What is needed is a device that can be carried outdoors to overcome these limitations that allows a hunter to imitate raking a tree and/or ground to attract wild game. Such bugle tubes are often bulky and are not strong enough to withstand use as a raking stick to imitate raking a tree and/or ground and can sound hollow and/or less natural when used for imitating a bull elk raking a tree and/or ground. What is needed is a single device that will allow a hunter to both imitate the raking of a tree and/or ground and also imitate the sounds of a bull elk call with the same device albeit at different times. What is also needed is a device that will allow hunters to imitate the raking of a tree and/or ground. What is also needed is a device that is rigid and solid for use with raking a tree or shrubbery yet less bulky than traditional bugles tubes to allow the user to easily carry and store the device in a backpack or backpack side pouch.

Embodiments of the present disclosure overcome these problems, and others, providing numerous benefits, by providing a raking stick and game call in one device that both imitates a bull elk raking a tree and/or ground and by blowing into one end with a user's mouth, producing an effective, tonal variety that can closely imitate the call of a bull elk, cow elk or calf elk sounds by providing a chamber through which air passes through the tube to make a game call sound. Advantages of such a device include avoiding the need to search for a stick or tree branch at the location the hunter desires to imitate raking a tree and/or ground, especially in areas where sticks and tree branches are not readily available. Other advantages include reducing the weight that must be carried by a hunter by combining the raking stick and bugle tube into one device. Another advantage of the device is that it mimics the sound of wild game and with more realistic sounds than some bugle tubes, based on the size and shape of the device including the shape of the inside of the tube and the length and thickness of the baffle portion. In one embodiment the inside shape of the device mimics the shape of an elk's esophagus. Another advantage is that the device can also mimic the sound of a bull elk glunking where a glunk is a muffled bass or deep popping sound, in single tones, one after the other in quick succession or various sequences. Another advantage is the durability of the device for repeated raking against a tree and/or ground. Another advantage is the ability to mimic the raking sound of a bull elk and then switch to mimicking the vocal sounds of a bull elk bugling or cow elk or calf elk sounds with the same device, or vice versa. Another advantage is the handle shape that makes it easier for a user to grip the device with the user's hand and makes gripping the device more comfortable for sustained periods of use for raking a tree and/or ground, and in the case of devices that include the bugle tube, for sustained bugling. The grip allows the user to hold the device comfortably while mimicking an elk call or elk sound and/or while using the device to rake a tree and/or ground.

There are numerous embodiments available for the handle of the device. One handle embodiment is a smooth surface on one end of the device of a diameter that is conducive to gripping the device. Another handle embodiment is to add a material over the handle section of the raking stick, such as cork, tape, rubber, foam, or a synthetic or natural material that assists with maintaining a solid grip. In some embodiments there may be a ridge on one end or the other of the grip section to keep the hand from sliding. Some embodiments may have a guard or shield forward of the hand grip to protect the hand.

There are numerous embodiments available for the baffle portion of the device. One embodiment has a baffle portion that is not tapered and the walls of the baffle portion are of a thickness that provides sufficient strength to withstand the force required to use the device as a raking stick against trees and other vegetation. In one embodiment the baffle portion also has thicker material reinforcement sections to strengthen the baffle portion. In one embodiment the thickness of the material on the baffle portion is less in sections of the baffle portion to reduce the overall weight of the device. In one embodiment the baffle portion has four raised ridges running most of the length of the device to provide strength to the baffle portion to withstand the force resulting from rubbing the baffle portion of the device on trees and vegetation.

While many bugle tubes have tapered baffle portions and larger air chambers to mimic the sound of an elk, in one embodiment inside diameter of the baffle portion is consistent the length of the baffle portion and is greater than the diameter of the handle portion and the thickness of the baffle wall combined with the length of the baffle portion creates realistic elk sounds. This results in the ability to produce similar elk sounds with a device that is not as bulky as most baffle style bugle tubes which makes the device easier to carry and store.

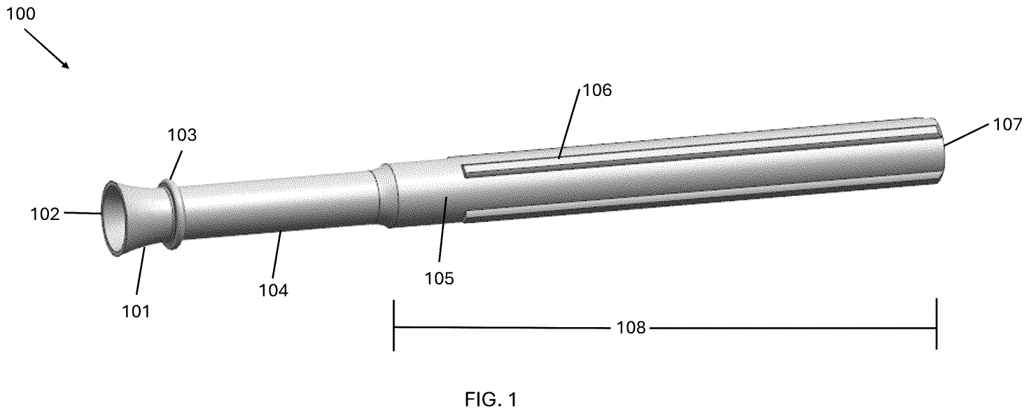

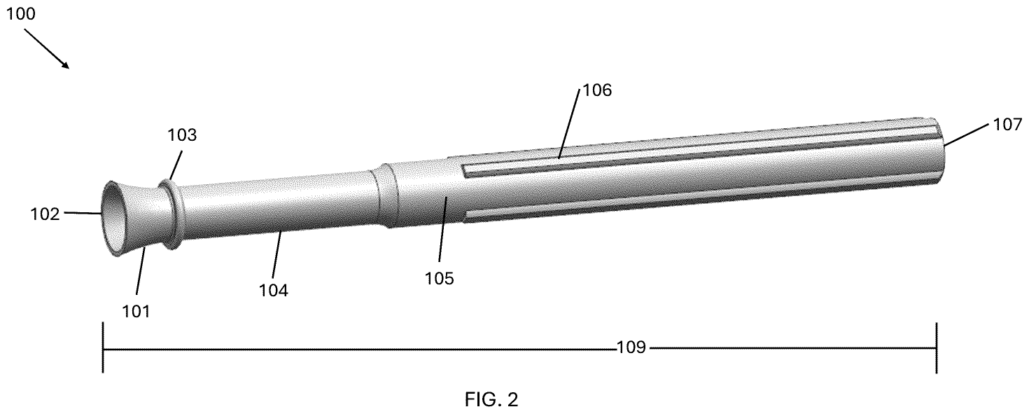

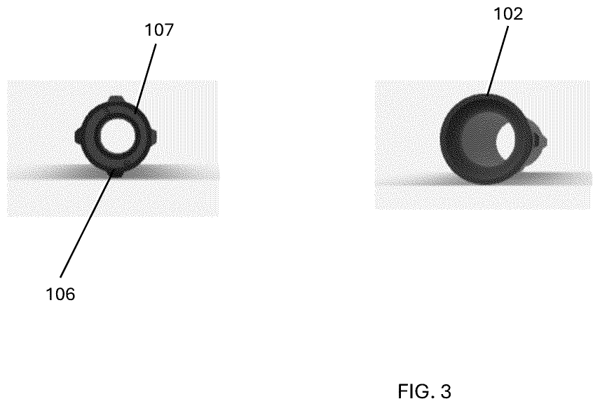

FIGS. 1, 2 and 3 show an embodiment of a raking stick game calling device 100. Raking stick game calling device 100 may comprise: a raking stick bugle tube device made of a nylon (polyamide, PA), polycarbonate (PC), polyethylene (PE), polyoxymethylene (POM), polypropylene (PP), polystyrene (PS), thermoplastic elastomer (TPE), thermoplastic polyurethane (TPU), composite, plastic, wood, metal, or fiberglass, or a combination of these materials, wherein the device 100 is hollow and has a fluted or flared end 102 for a mouthpiece portion 101 followed by a raised section 103 to facilitate gripping or avoid sliding of the hand when using the device, followed by a section 104 for gripping the device, wherein the device then has a baffle portion 105 with reinforcement sections 106 along the baffle portion out to the end of the baffle portion 107 to reinforce or strengthen the portion of the tube which is used for raking against trees. The raised sections 106 for reinforcement can be different widths and heights and can be any number. The raised reinforcement sections 106 can run the length of the tube or just a portion of the tube. The diameter of the tube is consistent where the reinforcement sections are located and that portion of the tube does not taper. The device is hollow to allow user to place his/her mouth against the mouthpiece portion 102 and blow air through the tube which allows air to flow from one end 102 to the other 107 to mimic the sound of an elk. The inside of the tube may be the same diameter throughout the length of the tube. The inside of the tube may be different diameters for different sections. The inside of the tube may have raised rings or raised portions to mimic the shape of an elk's esophagus. The device 100 may also be used by gripping the handle 104 of the device and using the device to rub against vegetation such as a tree, bush, shrub, and/or the ground in order to mimic the sound of a bull elk raking its antler(s) against the vegetation and/or ground. The device 100 may also be used by gripping the handle 104 of the device and placing the user's lips against the mouthpiece 102 end of the device and blowing into the device to mimic the sound of an elk. The device 100 may also be used by gripping the handle 104 of the device in one hand and using the user's other hand to slap the palm portion of its hand against the mouthpiece 102 end of the device or the end 107 of the device to mimic the sound of a bull elk glunking. The handle portion 104 of the device may be smooth, textured, ribbed, or otherwise structured to allow for better grip by the user's hand. The length of the tube 109 can be any length but the ideal length is between 23 and 26 inches in length. The tube is less than 3 inches in diameter at its largest diameter. The tube can be one piece. The smaller diameter of the tube allows it to fit more easily in a backpack or backpack pocket. The raking portion 105 of the device may be cylindrical with even diameter. The device has a flared end 101 for a mouthpiece 102 with a raised portion 103 to assist with grip, and a grip or handle section 104 which transitions to the raking section 108 which is reinforced with additional material 106 along the portion that will be used for raking. The device is hollow to allow air to flow from one end 102 to the other 107 to mimic the sound of an elk. The section of the device which is reinforced 105 does not need to taper. The raking portion 105 of the device which is adjacent to the grip or handle section is flat and is not tapered. The thickness of the device is such that the device is rigid to withstand the wear and tear of raking a tree and such thicker material combined with the length of the device results in a more realistic elk sound imitation.

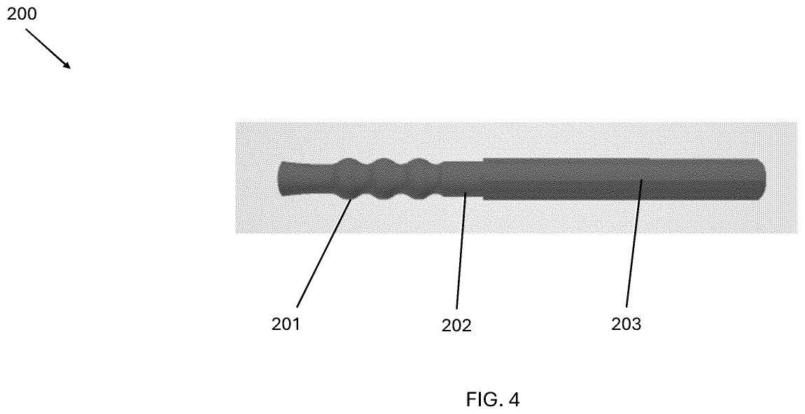

FIG. 4 shows an embodiment of a raking stick game calling device 200. Raking stick game calling device 200 may comprise: a raking stick bugle tube device made of a nylon (polyamide, PA), polycarbonate (PC), polyethylene (PE), polyoxymethylene (POM), polypropylene (PP), polystyrene (PS), thermoplastic elastomer (TPE), thermoplastic polyurethane (TPU), composite, plastic, wood, metal, or fiberglass, or a combination of these materials, wherein the device is hollow and has a fluted or flared end followed by a raised section to facilitate gripping or avoid sliding of the hand when using the device, followed by a section formed with raised mounds or ribs 201 for gripping the device, wherein the device then has a tube like contour 202 with raised sections 203 to reinforce or strengthen the bulk of the tube which is used for raking against trees and/or ground. The raised sections 203 for reinforcement can be different widths and heights and can be any number. The raised sections can run the length of the tube or just a portion of the tube. The device is hollow to allow air to flow from one end to the other to mimic the sound of an elk. The inside of the tube may be the same diameter throughout the length of the tube. The inside of the tube may be different diameters for different sections. The inside of the tube may have raised rings or raised portions to mimic the shape of an elk's esophagus. The device 200 may be used by gripping the handle 201 of the device and using the baffle portion 202 of the device to rub against vegetation such as a tree, bush or shrub in order to mimic the sound of a bull elk raking its antler(s) against the vegetation and/or ground. The device 200 may also be used by gripping the handle of the device and placing the user's lips against the mouthpiece end of the device and blowing into the device to mimic the sound of an elk. The device 200 may also be used by gripping the handle of the device in one hand and using the user's other hand to slap the palm portion of its hand against the mouthpiece end of the device to mimic the sound of bull elk glunking.

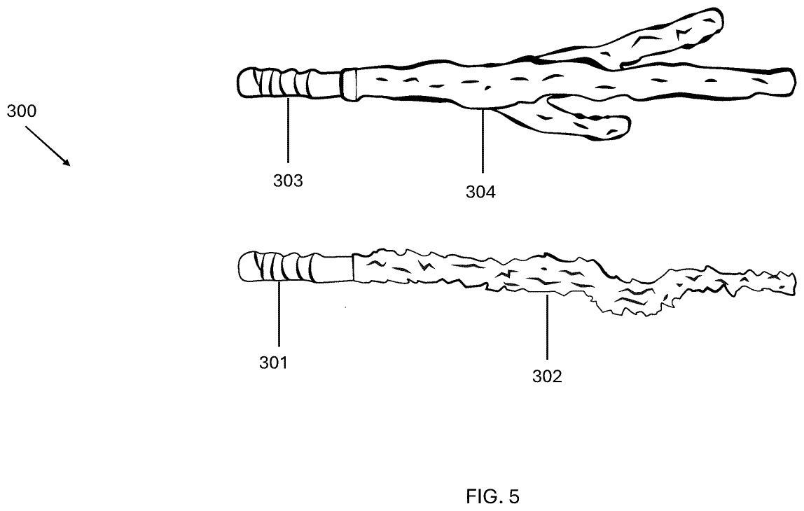

FIG. 5 shows two embodiments of a raking stick game calling device 300. Raking stick game calling device 300 may comprise: a raking stick that is solid or hollow and shaped to look like an elk antler with one or more antler points 304 and a smooth surface or a surface 302 that emulates the texture of a real elk antler. The raking stick device 300 has a handle portion 301 or 303 followed by a portion that emulates an elk antler 302 or 304. The elk antler portion may be consistently uniform in diameter and texture or it may be of varying diameters and textures on the surface. The device 300 may comprise a raking stick device made of a nylon (polyamide, PA), polycarbonate (PC), polyethylene (PE), polyoxymethylene (POM), polypropylene (PP), polystyrene (PS), thermoplastic elastomer (TPE), thermoplastic polyurethane (TPU), composite, plastic, wood, metal, or fiberglass, or a combination of these materials, wherein the handle portion 301 or 203 may be bare or may have a material overlaid on the handle portion, such as cork, tape, foam, rubber, wood, fiberglass or metal. The device 300 may be any length and the antler portions may be of varying length or consistent length to emulate an elk antler. The device may be hollow to reduce weight or may be solid to increase the strength of the device to withstand the force applied to the device when in use raking a tree or the ground. The device 300 may be used by gripping the handle 301 or 303 of the device and using the antler-like portion 302 or 304 of the device to rub against vegetation such as a tree, bush or shrub in order to mimic the sound of a bull elk raking its antler(s) against the vegetation and/or ground.

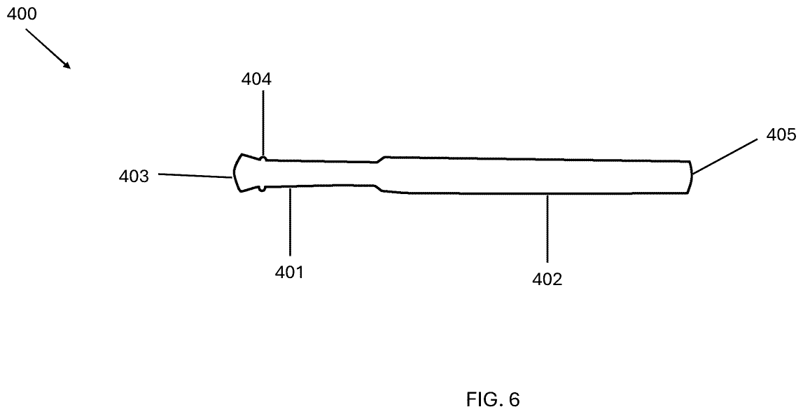

FIG. 6 shows an embodiment of a raking stick game calling device 400. Raking stick game calling device 400 may comprise: a raking stick bugle tube device made of a nylon (polyamide, PA), polycarbonate (PC), polyethylene (PE), polyoxymethylene (POM), polypropylene (PP), polystyrene (PS), thermoplastic elastomer (TPE), thermoplastic polyurethane (TPU), composite, plastic, wood, metal, or fiberglass, or a combination of these materials, wherein the device is hollow and has a fluted or flared end 403 followed by a raised section 404 to facilitate gripping or avoid sliding of the hand when using the device, followed by a flat section 401 for gripping the device, wherein the device then has a tube like contour 402 that is greater in diameter than the grip section and has a cylindrical form from one end to the other 405 of the tube which is the portion used for raking against trees and/or the ground. The device may be hollow to allow air to flow from one end to the other to mimic the sound of an elk. The inside of the tube may be the same diameter throughout the length of the tube. The inside of the tube may be different diameters for different sections. The inside of the tube may have raised rings or raised portions to mimic the shape of an elk's esophagus. The device 400 may be used by gripping the handle 401 of the device and using the device to rub against vegetation such as a tree, bush, shrub and/or the ground in order to mimic the sound of a bull elk raking its antler(s) against the vegetation or ground. The device 400 may also be used by gripping the handle 401 of the device and placing the user's lips against the mouthpiece end 403 of the device and blowing into the device to mimic the sound of an elk. The device 400 may also be used by gripping the handle 401 of the device in one hand and using the user's other hand to slap the palm portion of its hand against the mouthpiece end 403 or the other end 405 of the device to mimic the sound of bull elk glunking.

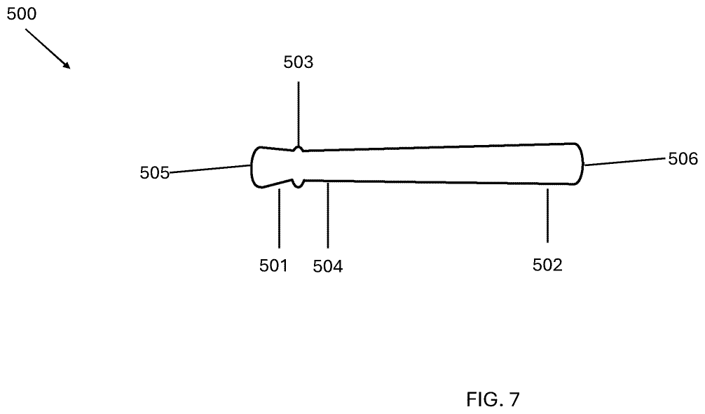

FIG. 7 shows an embodiment of a raking stick game calling device 500. Raking stick game calling device 500 may comprise: a raking stick bugle tube device made of a nylon (polyamide, PA), polycarbonate (PC), polyethylene (PE), polyoxymethylene (POM), polypropylene (PP), polystyrene (PS), thermoplastic elastomer (TPE), thermoplastic polyurethane (TPU), composite, plastic, wood, metal, or fiberglass, or a combination of these materials, wherein the device is hollow and has a fluted or flared end 501 followed by a raised section 503 to facilitate gripping or avoid sliding of the hand while using the device, followed by a baffle section that has a tube like contour 504 wherein the diameter of the baffle tube is greater on the far end 502 than it is in the grip portion 504 and wherein the section 502 following the grip stop 503 increases in diameter at a steady rate to produce different sounds while using the increasing diameter portion to rake against vegetation such as trees, shrubs, or bushes and/or the ground and to produce difference sounds while blowing air through the device. The increasing diameter portion can run the length of the tube or just a portion of the tube. The device may be hollow to allow air to flow from one end to the other to mimic the sound of an elk. The inside of the tube may be the same diameter throughout the length of the tube. The inside of the tube may be different diameters for different sections. The inside of the tube may have raised rings or raised portions to mimic the shape of an elk's esophagus. The device 500 may be used by gripping the handle 504 of the device on the other side of the grip stop 503 from the flared mouthpiece 501 portion, and using the device to rub against vegetation such as a tree, bush, shrub and/or the ground in order to mimic the sound of a bull elk raking its antler(s) against the vegetation or ground. The device 500 may also be used by gripping the handle 504 of the device and placing the user's lips against the mouthpiece end of the device and blowing into the device to mimic the sound of an elk. The device 500 is also used by gripping the handle 504 portion of the device in one hand and using the user's other hand to slap the palm portion of its hand against the mouthpiece end or the other end of the device to mimic the sound of bull elk glunking.

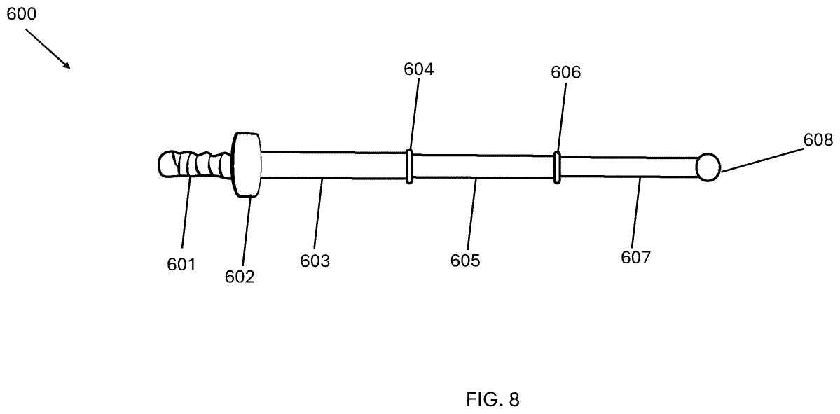

FIG. 8 shows an embodiment of a raking stick game calling device 600. Raking stick game calling device 600 may comprise: a raking stick that is solid or hollow with a handle section 601 and two or more rod sections 603, and/or 605 and/or 607 that telescope one into the other with the option of adding a weight 608 at the far end of the furthest telescoping rod from the handle. The device 600 telescoping rods fitted with hardware 604 and/or 606 to allow the telescoping rods to lock into position at the desired length. The device 600 may comprise a strong material such as carbon, steel, aluminum, fiberglass or a plastic-like material such as nylon (polyamide, PA), polycarbonate (PC), polyethylene (PE), polyoxymethylene (POM), polypropylene (PP), polystyrene (PS), thermoplastic elastomer (TPE), thermoplastic polyurethane (TPU), composite, or a combination of these materials. The handle portion may be bare or may have a material overlaid on the handle portion, such as cork, tape, foam, rubber, wood, fiberglass or metal. The device 600 may have a shield 602 to create a barrier to protect the user's hand when using the device and may have a cloth or other material that covers the hand to protect it from hitting the tree when using the raking stick. The device 600 may have a weight 608 placed at the end of the last telescoping rod to make the device heavier when being used to rake a tree and/or ground. The weight may be permanently fixed to the device or removable. The device 600 may be used by extending the one or more of the rod sections and locking them in place at the desired length, then gripping the handle 601 portion of the device and using the device to rub against the ground and/or vegetation such as a tree, bush, shrub and/or the ground in order to mimic the sound of a bull elk raking its antler(s) against the vegetation.

In an embodiment, a method of making a raking stick game calling device may comprise: heating & injecting plastic material under pressure into a closed metal mould tool. The molten plastic cools & hardens into the shape inside the mold tool, which then opens to allow the mouldings to be ejected or removed for inspection, delivery or secondary operations. In another embodiment, a method of making a raking stick game calling device may comprise alternative plastic manufacturing processes like CNC Machining, thermoset compression molding, blow molding, and 3D printing. These other manufacturing processes can offer various advantages like durability, weight, efficiency, and affordability.

In various implementations of the embodiments described herein, the device may comprise various materials. In an implementation, the device may comprise a nylon (polyamide, PA) material. In an implementation the device may comprise a polycarbonate (PC) material. In an implementation, the device may comprise a polyethylene (PE). In an implementation, the device may comprise a polyoxymethylene (POM). In an implementation, the device may comprise a polypropylene (PP) material. In an implementation, the device may comprise a polystyrene (PS) material. In an implementation, the device may comprise a thermoplastic elastomer (TPE) material. In an implementation, the device may comprise a thermoplastic polyurethane (TPU) material. In an implementation, the device may comprise a wood material. In an implementation, the device may comprise a carbon material. In an implementation, the device may comprise a metal material. In an implementation, the device may comprise a composite material. In an implementation, the device may comprise a plastic material. In an implementation, the device may comprise a combination of one or more of these materials.

The description in combination with the figures is provided to assist in understanding the teachings disclosed herein. The following discussion will focus on specific implementations and embodiments of the teachings. This focus is provided to assist in describing the teachings and should not be interpreted as a limitation on tope or applicability of the teachings. However, other embodiments can be used based on the teachings as disclosed in this application.

The terms “comprises,” “comprising,” “includes,” “including,” “has,” “having” or any other variation thereof, are intended to be a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive meaning of “or” and not to an exclusive meaning of “or.” For example, a condition A or B is satisfied by any one of the following: A is true (or present), and B is false (or not present), A is false (or not present), and B is true (or present), and both A and B are true (or present).

Also, the use of the terms “a” or “an” is employed to describe elements and components herein. This is done merely for convenience and to give a general sense of the scope of the embodiments. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

As used herein, the terms “generally equal,” “generally same,” “substantially,” and the like, refer to deviations of no greater than 10% of a chosen value. For more than two values, the deviation can be measured with respect to a central value. For example, “generally equal” refers to two or more conditions that are no greater than 10% different in value. Demonstratively, angles offset from one another by 98% are generally perpendicular.

Unless otherwise defined, technical and scientific terms used herein have the same meaning as commonly understood by one of ordinary skill in the art to which these embodiments belong. The materials, methods, and examples are illustrative only and not intended to be limiting. To the extent not described herein, many details regarding specific materials and processing acts are conventional and may be found in textbooks and other sources within the wild game calling arts.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges include each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A raking stick game calling device, comprising:
a hollow tube configured to generate sound waves by vibrating responsive to air flowing through the hollow tube, the hollow tube comprising:
a first end comprising a first aperture;
a wall extending from the first end to a second end opposite the first end, the wall having an inner surface defining an interior volume;
wherein the first aperture provides access to the interior volume;
wherein a flow path is defined through the hollow tube from the first end, through the interior volume, and out the second end;
and a handle portion positioned between the first end and the second end;
and a baffle portion wherein the baffle portion is reinforced for strength and wherein the exterior surfaces of the baffle portion are parallel to one another and not tapered.

2. The raking stick game calling device of claim 1, wherein the first end comprises a first aperture flared as a mouthpiece.

3. The raking stick game calling device of claim 2, wherein the first aperture flared as a mouthpiece is located next to a raised portion of the device to provide a grip stop.

4. The raking stick game calling device of claim 3, wherein the device has a handle portion adjacent to the raised grip stop portion.

5. The raking stick game calling device of claim 1, wherein at least a section of the inner portion of the hollow tube is shaped with ribs to imitate an elk's esophagus.

6. The raking stick game calling device of claim 1, wherein the tube is formed of plastic.

7. The raking stick game calling device of claim 1, wherein the diameter of any portion of the device is not greater than 3 inches.

8. The raking stick game calling device of claim 1, wherein only a portion of the exterior wall of the tube is configured with reinforcement material to strengthen the exterior wall.

9. The raking stick game calling device of claim 1, wherein the baffle portion is a consistent outer diameter and is not tapered.

10. The raking stick game calling device of claim 1, wherein the thickness of the tube wall is thinner in sections to reduce weight.

11. The raking stick game calling device of claim 1, wherein the handle portion is textured or has a material overlaid on it to improve grip.

12. The raking stick game calling device of claim 1, wherein the device length is over 22.5 inches in overall length but under 26 inches in overall length.

13. A raking stick game calling device, comprising:
a solid tube comprising:
a first end comprising a handle;
a second end opposite the first end;
a wall extending from the handle to the second end;
the wall shaped in the form of an antler with one or more points;
the texture of the wall being smooth or having raised nodes like an elk antler.

14. The raking stick game calling device of claim 13, wherein the handle is wrapped in cork, foam, tape, or rubber.

15. The raking stick game calling device of claim 13, wherein the handle has a raised portion near the first end to form a grip stop for the hand.

16. The raking stick game calling device of claim 13, wherein the tube is formed of a plastic.

17. The raking stick game calling device of claim 13, wherein the overall length of the device is between 22 and 26 inches.

18. A raking stick game calling device, comprising:
a tube comprising:
a first end comprising a handle;
a first hollow tube connected to the handle end;
a second hollow tube connected the first hollow tube wherein the diameter of the second tube is less than the diameter of the first tube wherein the second tube is able to slide at least partially into the first tube and has a means for fixedly securing the second tube in position.

19. The raking stick game calling device of claim 18, wherein the second hollow tube has a weight attachable to the end of the second hollow tube.

20. The raking stick game calling device of claim 18, wherein the second hollow tube has a third hollow tube connected to it wherein the diameter of the third hollow tube is less than the diameter of the second hollow tube and the third hollow tube is able to slide at least partially into the second hollow tube and has a means for fixedly securing the second tube in position.
